(19) United States
(12) Patent Application Publication
(10) Pub. No.: US 2008/0083827 A1
(43) Pub. Date: Apr. 10, 2008

(54) Security method of dual-card assembly

(75) Inventor: Chun-Hsin Ho, Taipei (TW)

Correspondence Address: BACON & THOMAS, PLLC, 625 SLATERS LANE, FOURTH FLOOR, ALEXANDRIA, VA, 22314, US

(73) Assignee: Taisys Technologies Co., Ltd., Taipei (TW)

(21) Appl. No.: 11/543,884

(22) Filed: Oct. 6, 2006

(51) Int. Cl. G06K 5/00; H04B 1/38

(52) U.S. Cl. 235/380; 455/558

(57) ABSTRACT

A security method of a dual-card assembly for use in a communication terminal is disclosed. The security method includes the steps of: a) providing a first card; b) combining a second card with the first card to form the dual-card assembly; c) initializing the first card or the second card to activate a first identification code for the first card or a second identification code for the second card; and d) checking the initialized first identification code or second identification code, whereby the dual-card assembly will be disabled when the first card or the second card is replaced with another card or when either the first identification code or the second identification code is invalidated.

### FIELD OF THE INVENTION

The present invention relates to a dual-card system, and more particularly, to a security method of a dual-card assembly for use in a communication terminal, i.e., a mobile phone.

### BACKGROUND OF THE INVENTION

Generally, there are many types of telecommunication networks, which have been established for providing a variety of services to network subscribers. Certainly, the widely used and well-known service provided by the telecommunication networks is mobile phone service, such as with cellular telephones. Meanwhile, several surface contacting cards with special circuits are widely used in electronic devices to enhance the functions of the electronic devices for providing more services. For example, a subscriber identity module (SIM) card could be placed in a portable phone to dedicate the phone's functions to the SIM card owner. By means of changing SIM cards, a single phone can be used by many SIM card owners as a personal phone. Furthermore, some telecommunication networks provide other services that involve banking operations and transaction functions. Therefore, the secure transmission is more and more important.

As we know, the SIM cards are most commonly used in communication devices to enable a user to access an individual account or a particular wireless telephone network. Each SIM card contains the configuration information for a designated network, and also contains information identifying the user, such as the user's mobile telephone number. Moreover, other external IC cards could be used in numerous applications such as payment to form the so-called “multi-application cards”. Meanwhile, an integrated subscriber identification module (SIM) card system for use with a communication terminal could be introduce a dual card system for use with a transaction terminal and a communication terminal for serving a payment function by means of contactless transaction card in a size that is easily and conveniently stored in a mobile phone. Certainly, the security of a dual-card assembly for use in a communication terminal is very important. Furthermore, in practice, the problems ensuing from stolen and forged credit cards and cash cards are becoming more and more serious, and increased efforts are being made to reduce the risks involved in this respect. Many solutions have been proposed, including time limits, limited withdrawals, duplicate encryption, and the identification of the card owner with all manner of means ranging from PIN codes to fingerprints, one-time passwords, etc. Regardless of the solutions applied, a fraudulent person is able to pass through the different barriers and obstacles with the aid of ever more sophisticated methods.

Although some multi-application cards including functions of a mobile phone and a credit card are technically feasible, in practice they are very difficult to implement or fail to disclose an effective security system for avoiding misappropriation. Therefore, it needs to provide a security method of a dual-card assembly for use in a communication terminal, which is capable of serving a payment function by means of contactless transaction card in a size that is easily and conveniently stored in a mobile phone and further provides a mutual security of dual cards for avoiding misappropriation, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a security method of a dual-card assembly for use in a communication terminal, which is capable of serving a payment function by means of contactless transaction card in a size that is easily and conveniently stored in a mobile phone and further provides a mutual security of dual cards for avoiding misappropriation, and can rectify those drawbacks of the prior art and solve the above problems.

In accordance with an aspect of the present invention, the security method of a dual-card assembly for use in a communication terminal, includes the steps of: a) providing a first card; b) combining a second card with the first card to form the dual-card assembly; c) initializing the first card or the second card to activate a first identification code for the first card or a second identification code for the second card; and d) checking the initialized first identification code or second identification code, whereby the dual-card assembly will be disabled when the first card or the second card is replaced with another card or when either the first identification code or the second identification code is invalidated.

Certainly, the dual-card assembly can be inserted into a SIM socket of the communication terminal.

Preferably, the communication terminal is one of a mobile phone and a personal digital assistant.

Preferably, the first identification code and the second identification code are recorded in a first memory of the first card and a second memory of the second card, respectively.

Preferably, the first memory and the second memory each is a flash memory or an EEPROM.

Preferably, the first card is a SIM.

Preferably, the first identification code is a personal identification number (PIN), an International Mobile Subscriber Identity (IMSI), or an Integrated Circuit Card Identification (ICCID) of the SIM.

Preferably, the second card is a transaction card.

Preferably, the second identification code is a personal identification number (PIN) of the transaction card.

Preferably, the step c) or d) is accomplished by over-the-air (OTA) manner.

Preferably, the step d) is accomplished by the second card.

In accordance with another aspect of the present invention, the security method of a dual-card assembly for use in a communication terminal, includes the steps of: a) providing a first card; b) combining a second card with the first card to form a dual-card assembly; c) initializing the first card or the second card to activate a first identification code for the first card or a second identification code for the second card; d) checking the initialized first identification code or the second identification code; e) invalidating the first identification code under the authorization by the service provider while the first card is missing or to be substituted; f) replacing the first card with a third card having a third identification code to form a new dual-card assembly; and g) activating the third identification code; and h) checking the third identification code.

Preferably, the communication terminal is one of a mobile phone and a personal digital assistant.

Preferably, the first card and the third card each is a SIM.

Preferably, the first identification code and the third identification code each is a personal identification number (PIN), an International Mobile Subscriber Identity (IMSI), or an Integrated Circuit Card Identification (ICCID) of the SIM.

Preferably, the second card is a transaction card.

Preferably, the second identification code is a personal identification number (PIN) of the transaction card.

Preferably, the step c), d), e), g) or h) is accomplished by over-the-air (OTA) manner.

The above objects and advantages of the present invention will become more readily apparent to those ordinarily skilled in the art after reviewing the following detailed description and accompanying drawings, in which:

### BRIEF DESCRIPTION OF THE DRAWING

FIG. 1 illustrates a security method of a dual-card assembly for use in a communication terminal according to the present invention;

FIG. 2 illustrates a flow chart of security method of the dual-card assembly for use in a communication terminal according to the present invention;

FIG. 3 illustrates another security method of a dual-card assembly for use in a communication terminal according to the present invention; and

FIG. 4 illustrates a flow chart of another security method of the dual-card assembly for use in a communication terminal according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

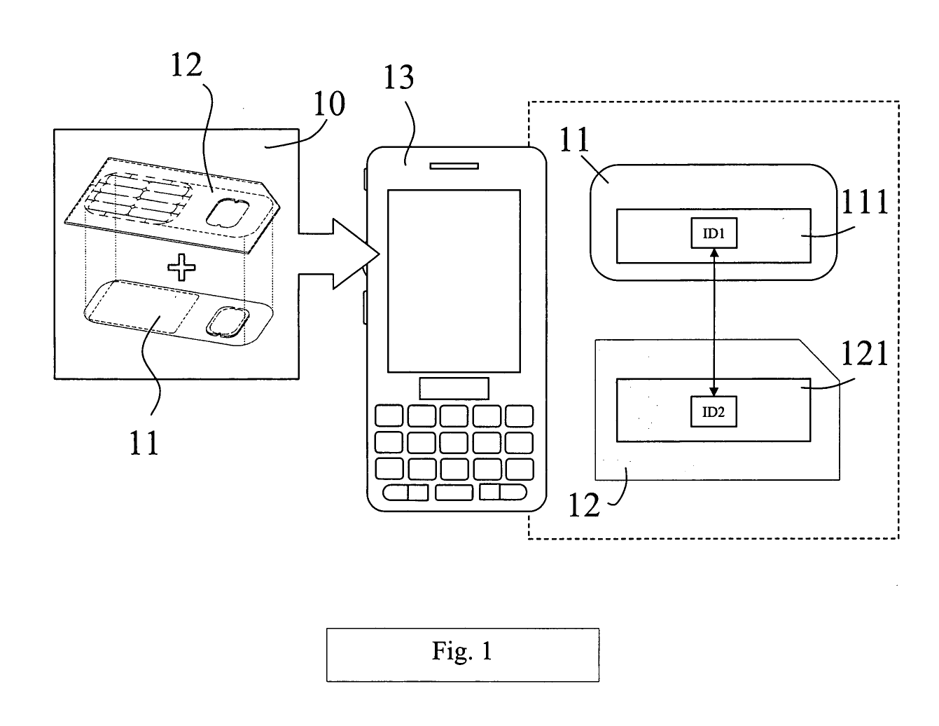

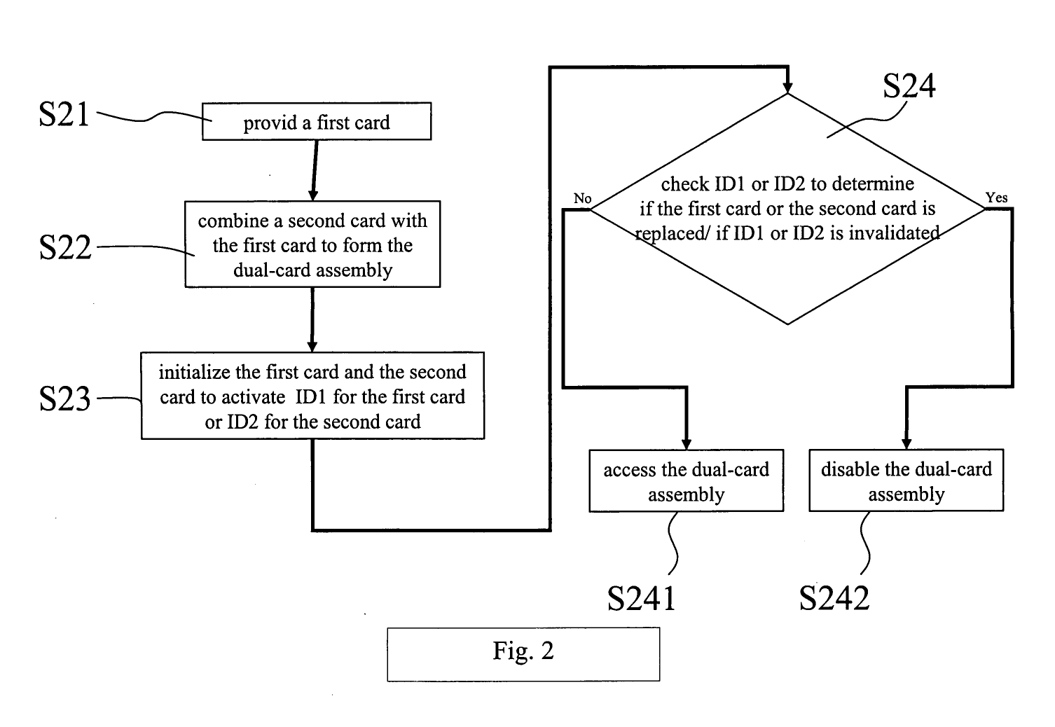

Please refer to FIG. 1 and FIG. 2. They illustrate a security method of a dual-card assembly for use in a communication terminal according to the present invention. As shown in FIG. 1 and FIG. 2, the security method of the present invention includes the following steps: a) providing a first card 11, as shown in step S21; b) combining a second card 12 with the first card 11 to form the dual-card assembly 10, as shown in step S22; c) initializing the first card 11 or the second card 12 to activate a first identification code ID1 for the first card 11 or a second identification code ID2 for the second card 12, as shown in step S23; and d) checking the initialized first identification code ID1 or second identification code ID2 to determine if the first card 11 or the second card 12 is replaced with another card; or either the first identification code ID1 or the second identification code ID2 is invalidated, as shown in step S24. Meanwhile the dual-card assembly 10 will be disabled when the first card 11 or the second card 12 is replaced with another card or when either the first identification code ID1 or the second identification code ID2 is invalidated, as shown in step S242. Otherwise, the communication terminal 13 is capable of accessing to the dual-card assembly 10.

Certainly, the dual-card assembly 10 can be inserted into a SIM socket of the communication terminal 13. In practice, the communication terminal 13 is one of a mobile phone and a personal digital assistant. The first identification code ID1 and the second identification code ID2 are recorded in a first memory 111 of the first card 11 and a second memory 121 of the second card 12, wherein the first memory 111 and the second memory 121 each is a flash memory or an EEPROM. In this embodiment, the first card 11 is a SIM, and then the first identification code ID1 is a personal identification number (PIN), an International Mobile Subscriber Identity (IMSI), or an Integrated Circuit Card Identification (ICCID) of the SIM. Furthermore, the second card 12 is a transaction card; and the second identification code ID2 is a personal identification number (PIN) of the transaction card.

Moreover, the step c) or d) is accomplished by over-the-air (OTA) manner. The OTA configuration enables mobile network operators and wireless service providers to add new services to a customer's handset by using the wireless network. Certainly, the step d) can be also accomplished by the second card 12. In this embodiment, the dual-card assembly could have a transaction card to be the second card 12 and a flexible SIM sheet to be the first card 11. Meanwhile the transaction card is shaped into a standard SIM card and further provides integrated functions of credit card and multi-application card. On the other hand, the dual-card assembly also includes a flexible SIM sheet for performing communication operation for the communication terminal. Meanwhile, the flexible SIM sheet has an engagement mechanism to engage with the transaction card such that the flexible SIM sheet can be laminated on the transaction card to be inserted into a standard SIM socket of the communication terminal. Therefore, the dual-card assembly of the present invention is capable of serving a payment function by means of contactless transaction card in a size that is easily and conveniently stored in a mobile phone. Moreover, the dual-card assembly of the present invention further provides a mutual security of dual cards by means of introducing exclusive codes, which are activated in an initializing step for avoiding misappropriation. Obviously, the prior art fails to disclose that.

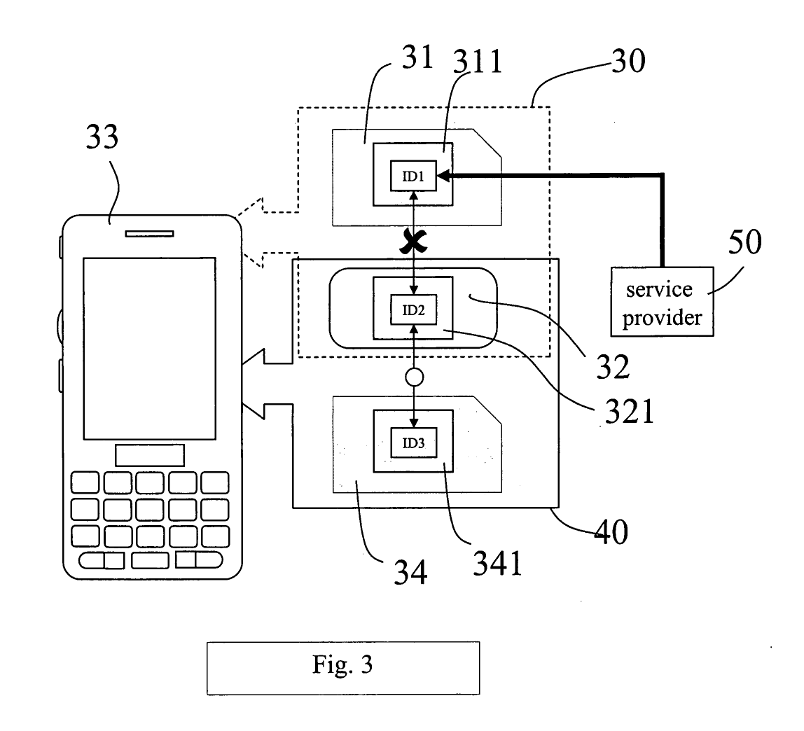

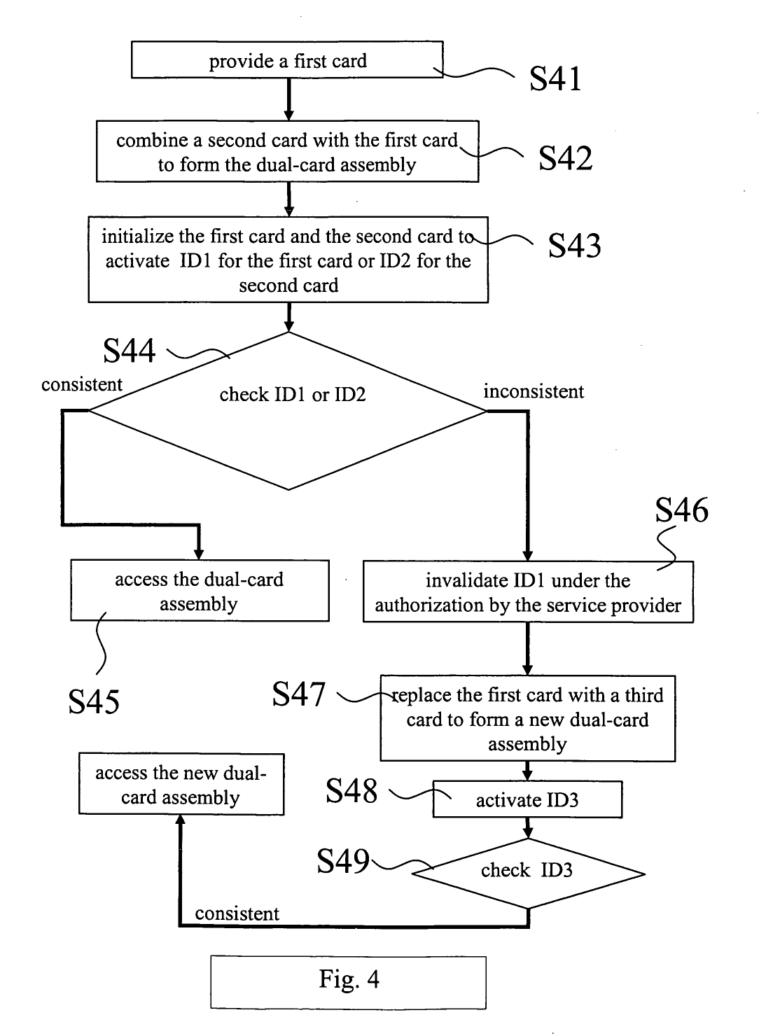

Please refer to FIG. 3 and FIG. 4. They illustrate another security method of a dual-card assembly for use in a communication terminal according to the present invention. As shown in FIG. 3 and FIG. 4, the security method of the present invention includes the steps of: a) providing a first card 31, as shown in step S41; b) combining a second card 32 with the first card 31 to form a dual-card assembly 30, as shown in step S42; c) initializing the first card 31 or the second card 32 to activate a first identification code ID1 for the first card 31 or a second identification code ID2 for the second card 32, as shown in step S43; d) checking the initialized first identification code ID1 or the second identification code ID2, as shown in step S44, wherein the dual-card assembly 30 is accessed while the first identification code ID1 or the second identification code ID2 is consistent, as shown in step S45, or else the next step is executed; e) invalidating the first identification code ID1 under the authorization by the service provider 50 while the first card 31 is missing or to be substituted, as shown in step S46; f) replacing the first card 31 with a third card 34 having a third identification code ID3 to form a new dual-card assembly 40, as shown in step S47; and g) activating the third identification code ID3, as shown in step S48; and h) checking the third identification code ID3, as shown in step S49. Certainly, the new dual-card assembly 40 will be disabled when the third card 34 or the second card 32 is replaced with another card or when either the third identification code ID3 is invalidated. Otherwise, the communication terminal 33 is capable of accessing to the new dual-card assembly 40.

Similarly, the communication terminal 33 is one of a mobile phone and a personal digital assistant. The first identification code ID1 and the second identification code ID2 are recorded in a first memory 311 of the first card 31 and a second memory 321 of the second card 32, wherein the first memory 311 and the second memory 321 each is a flash memory or an EEPROM. In this embodiment, the first card 31 is a SIM, and then the first identification code ID1 is a personal identification number (PIN) of the SIM. Certainly, the first identification code ID1 can be an International Mobile Subscriber Identity (IMSI) or an Integrated Circuit Card Identification (ICCID) of the SIM. Furthermore, the second card 32 is a transaction card; and the second identification code ID2 is a personal identification number (PIN) of the transaction card. Accordingly, the third card 34 is a SIM, too; and then the third identification code ID3 recorded in a third memory 341 of the third card 34 is a personal identification number (PIN) of the SIM. Certainly, the third identification code ID3 can be an International Mobile Subscriber Identity (IMSI) or an Integrated Circuit Card Identification (ICCID) of the SIM.

For contactless application, the step c), d), e), g) or h) can be also accomplished by over-the-air (OTA) manner. In the present invention, the identification code is activated to be exclusive. After initialization, the dual-card assembly is an integrated card, wherein two combined cards have exclusive codes for authorization. If one of two combined cards is replaced or missing, the identification code of the replaced or missing one would be invalidated and the new dual-card assembly should be re-activated again. Therefore, the dual-card assembly of the present invention further provides a mutual security of dual cards by means of introducing exclusive codes in an initializing step for avoiding misappropriation.

In conclusion, the present invention provides a security method of a dual-card assembly for use in a communication terminal, which is capable of serving a payment function by means of contactless transaction card in a size that is easily and conveniently stored in a mobile phone and further provides a mutual security of dual cards by means of introducing exclusive codes in an initializing step for avoiding misappropriation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A security method of a dual-card assembly for use in a communication terminal, comprising the steps of:
a) providing a first card;
b) combining a second card with said first card to form said dual-card assembly;
c) initializing said first card or said second card to activate a first identification code for said first card or a second identification code for said second card; and
d) checking said initialized first identification code or second identification code,
whereby said dual-card assembly will be disabled when said first card or said second card is replaced with another card or when either said first identification code or said second identification code is invalidated.

2. The security method according to claim 1, wherein said dual-card assembly can be inserted into a SIM socket of said communication terminal.

3. The security method according to claim 1, wherein said communication terminal is one of a mobile phone and a personal digital assistant.

4. The security method according to claim 1, wherein said first identification code and said second identification code are recorded in a first memory of said first card and a second memory of said second card, respectively.

5. The security method according to claim 4, wherein said first memory and said second memory each is a flash memory or an EEPROM.

6. The security method according to claim 1, wherein said first card is a SIM.

7. The security method according to claim 6, wherein said first identification code is a personal identification number (PIN), an International Mobile Subscriber Identity (IMSI), or an Integrated Circuit Card Identification (ICCID) of said SIM.

8. The security method according to claim 1, wherein said second card is a transaction card.

9. The security method according to claim 8, wherein said second identification code is a personal identification number (PIN) of said transaction card.

10. The security method according to claim 1, wherein said step c) or d) is accomplished by over-the-air (OTA) manner.

11. The security method according to claim 8, wherein said step d) is accomplished by said second card.

12. A security method for a communication terminal in communication with a service provider, comprising the steps of:
a) providing a first card;
b) combining a second card with said first card to form a dual-card assembly;
c) initializing said first card or said second card to activate a first identification code for said first card or a second identification code for said second card;
d) checking said initialized first identification code or said second identification code;
e) invalidating said first identification code under the authorization by said service provider while said first card is missing or to be substituted;
f) replacing said first card with a third card having a third identification code to form a new dual-card assembly;
g) activating said third identification code; and
h) checking said third identification code.

13. The security method according to claim 12, wherein said communication terminal is one of a mobile phone and a personal digital assistant.

14. The security method according to claim 12, wherein said first card and said third card each is a SIM.

15. The security method according to claim 14, wherein said first identification code and said third identification code each is a personal identification number (PIN), an International Mobile Subscriber Identity (IMSI), or an Integrated Circuit Card Identification (ICCID) of said SIM.

16. The security method according to claim 12, wherein said second card is a transaction card.

17. The security method according to claim 16, wherein said second identification code is a personal identification number (PIN) of said transaction card.

18. The security method according to claim 12, wherein said step c), d), e), g) or h) is accomplished by over-the-air (OTA) manner.
